(19) United States
(12) Patent Application Publication
(10) Pub. No.: US 2024/0325239 A1
(43) Pub. Date: Oct. 3, 2024

(54) DEVICE FOR TREATING ORTHOSTATIC SYNCOPE AND METHODS THEREOF

(71) Applicant: Duke University, Durham, NC (US)

(72) Inventors: Marat Fudim, Durham, NC (US); Eric Richardson, Durham, NC (US); James Butch, Durham, NC (US); Valerie Cross, Durham, NC (US); Bidisha Nandi, Durham, NC (US); Richard Lyon, Durham, NC (US); Ravi Prakash, Durham, NC (US); Xinjie Ouyang, Durham, NC (US); Yu Miao, Durham, NC (US); Brian Weil, Durham, NC (US); Kishen Mitra, Durham, NC (US); Sara Taube, Durham, NC (US); William Tian, Durham, NC (US)

(21) Appl. No.: 18/618,762

(22) Filed: Mar. 27, 2024

Related U.S. Application Data
(60) Provisional application No. 63/454,987, filed on Mar. 28, 2023.

(51) Int. Cl. A61H 9/00

(52) U.S. Cl. CPC A61H 9/0092; A61H 2201/0103; A61H 2201/0107; A61H 2201/1253; A61H 2201/1621; A61H 2201/1626; A61H 2201/1652; A61H 2201/1664; A61H 2201/1685; A61H 2203/0406; A61H 2205/083

(57) ABSTRACT

A compression device is provided. The compression device includes at least one support, a pressure applicator connected to the at least one support and a regulator. The pressure applicator is configured to apply compressive pressure to a treatment zone on an abdomen of a subject. The regulator controls the amount of compressive pressure applied to the subject by the pressure applicator. The regulator controls an amount of the compressive pressure from a minimum pressure to a maximum pressure as selected by the subject.

### CROSS-REFERENCE TO RELATED APPLICATIONS

The present invention claims the benefit of U.S. Provisional Application Ser. No. 63/454,987, filed Mar. 28, 2023, which is hereby incorporated by reference in its entirety, including any figures, tables, and drawings.

### BACKGROUND

The autonomic nervous system controls blood pressure, heart rate, digestion, and breathing and is thus vitally important to one's health. Postural orthostatic tachycardia syndrome (POTS), orthostatic hypotension (OH) and neurogenic orthostatic hypotension (NOH) are types of dysautonomia that affect the body's nervous system. Patients with these conditions may experience fainting, dizziness, blurred vision, nausea, mental fogginess, and tingling, due to a lack of blood flow to the brain and upper body when standing or sitting up. The blood vessels in the lower body of affected patients do not properly constrict, which results in a drop in blood pressure and a lack of blood flow to the brain and upper body. As the heart fails to fight against gravity and force blood to the brain, blood pools in the abdominal blood vessels until the patient lies down again. Many patients with POTS, OH or NOH are unable to stand up and walk for a length of time which prohibits many POTS, OH or NOH patients from living normal lives. In serious cases, POTS or NOH may lead to hospice care and death.

POTS is a disorder in which a reduced volume of blood is pumped back into the heart after sitting up or standing up from a lying position. This lack of blood flow can cause lightheadedness or fainting and an increase in heart rate of over 30 bpm. POTS may be treated by some existing drugs, but these only alleviate POTS symptoms and are not always effective. POTS is a common condition affecting an estimated one to three million Americans. POTS is more common in women than men and is more likely to develop in adolescents and young adults. Many cases, approximately 70% to 80%, are diagnosed in women between the ages of 15 and 50.

OH is a common cause of syncope and is highly prevalent in patients with heart failure. OH is diagnosed in 5% to 11% of middle-aged adults and in approximately 20% to 30% of people age 65 years and older. Many of the medications used to treat heart failure decrease blood pressure and blunt the body's compensatory response to a drop in blood pressure contributing to OH making OH in heart failure patients a particularly challenging problem.

### BRIEF SUMMARY

The present disclosure provides systems and devices for providing compression pressure to a subject's abdomen to treat and relieve symptoms associated with POTS, OH, NOH or other similar conditions. Advantageously, the disclosed systems and devices provide a general, precise, focused, or select pressure to the abdomen to stimulate the autonomic nervous system, reduce decreases in blood pressure and venous pooling, maintain blood pressure while standing, walking, or sitting, and/or reduce increases in heart rate within a first minute of standing up from a supine position, thus allowing affected subjects to improve their health or mobility. The disclosed systems and devices are easy to use and allow a subject to select the amount of pressure provided.

A compression device as described herein is a wearable device including at least one support; a pressure applicator connected to the at least one support, the pressure applicator configured to apply compressive pressure to a treatment zone on an abdomen of a wearer; and a regulator for controlling the amount of compressive pressure applied to the wearer by the pressure applicator, the regulator for controlling an amount of the compressive pressure from a minimum pressure to a maximum pressure as selected by the wearer.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIGS. 1A and 1B illustrate an example compression device on a wearer.

FIGS. 2A to 2C illustrate a pressure applicator of the compression device of FIG. 1A in a disengaged configuration, an engaged configuration and a second engaged configuration, respectively.

FIGS. 3A, 3B and 3C illustrate optional straps on a wearer for use with the compression device of FIG. 1A.

FIGS. 4A to 4D illustrate an example compression device on a wearer.

FIG. 4E illustrates a perspective view of the compression device of FIG. 4A in an engaged configuration.

FIG. 5 illustrates components of the compression device of FIG. 4A.

FIGS. 6A and 6B illustrate an example of a compression device including a compression garment on a wearer.

FIG. 7 illustrates an example of a compression device including a compression garment on a wearer.

FIGS. 8A and 8B illustrate an example of a compression device including a compression garment on a wearer.

FIG. 9A illustrates an example of a compression device on a wearer having calibrated markings.

FIGS. 9B and 9C illustrate example straps of the compression device of FIG. 9A with calibration markings.

FIG. 9D illustrates a perspective view of the compression device of FIG. 9A.

FIG. 10A and FIG. 10B illustrate an example of a compression device having removable pads.

FIGS. 11A and 11B illustrate an example of a compression device on a wearer.

FIGS. 12A and 12B illustrate an example of a compression device having an inflatable bladder.

FIGS. 13A and 13B illustrate an example of a compression device having an inflatable bladder on a wearer.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The present disclosure provides systems and devices for providing compression pressure to a subject's abdomen to treat and relieve symptoms associated with POTS, OH, NOH or other similar conditions. POTS, OH and NOH may be treated by wearable medical devices, such as compression garments, that provide abdominal compression. However, available wearable medical devices provide constant abdominal compression when worn by the patient and consequently, do not allow patients to modulate the amount of abdominal pressure or selectively engage and disengage the abdominal pressure while wearing the garment.

Advantageously, the disclosed systems and devices provide a precise, focused, or select pressure to the abdomen to stimulate the autonomic nervous system, reduce decreases in blood pressure and venous pooling, maintain blood pressure while standing, walking, or sitting, and/or reduce increases in heart rate within a first minute of standing up from a supine position, thus allowing affected subjects to improve their health or mobility. The disclosed systems and devices are easy to use and allow a wearer to select an amount of pressure as desired to accommodate their symptoms and/or lifestyle, for example.

As described herein, compression devices for treating orthostatic syncope include a waist garment such as a belt, strap or support that is configured to be attached around a subject's abdominal region and a pressure component for generating and maintaining directed abdominal pressure to the subject's abdomen. Specifically, the pressure component applies a selected and/or prescribed therapeutic pressure to a portion of the abdomen.

The present inventors have shown that when the belt, strap or support is secured or tightened around the abdomen, the compression device can maintain a therapeutic pressure of, for example, 40 mmHg in some implementations and a therapeutic pressure of 95 to 150 mmHg in other implementations. This pressure improves blood flow to the upper half of the body, especially to the brain and reduces symptoms associated with POTS, OH and NOH such as lightheadedness and fainting following standing or sitting up from a lying down position. Improved blood flow to the brain may alleviate major hypotension symptoms for POTS, OH and NOH patients. The wearer may decrease the amount of pressure applied by loosening the belt, strap or support and/or deactivating the pressure component.

Certain implementations of the presently described approaches have several advantages over conventional abdominal binders because the certain implementations of the described compression devices are able to sustain abdominal compression pressure, are easy to assemble, are easy to take on and off, are easy to clean, are anti-bacterial or washable, are concealable or discreet under clothing, and can be adjusted to accommodate wide variety of body habitus. Certain implementations of the described devices fill an unmet market need by allowing patients to engage or disengage the pressure mechanism at will, allowing greater quality of treatment without additional cost.

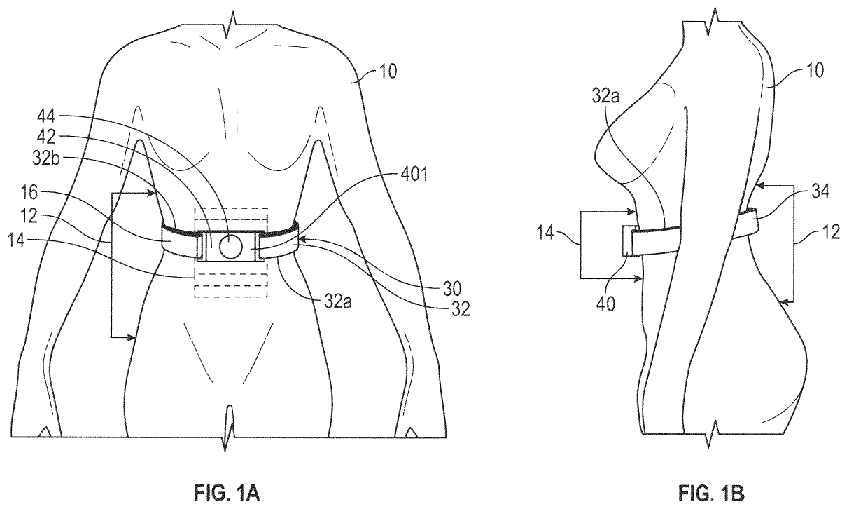

FIGS. 1A and 1B illustrate an example prototype compression device on a wearer according to an implementation of the present disclosure. FIGS. 1A and 1B illustrate a ventral side of an abdomen 12 of a subject 10 including a treatment zone 14. Treatment zone 14 is generally located between a subject's rib cage and pelvis area. Treatment zone 14 may encompass a subject's umbilical region, and/or waistline and include the area above, at or below the umbilical region. A size and shape of treatment zone 14 may vary depending upon each subject 10 and the compression device.

As illustrated in FIGS. 1A and 1B, compression device 30 is positioned around a waist 16 of subject 10. In this implementation, treatment zone 14 is at and/or above the umbilical region on a ventral side of abdomen 12. Compression device 30 includes an adjustable waist strap 32, a buckle 34 and a pressure applicator 40. Strap 32 supports pressure applicator 40 such that pressure applicator is positioned adjacent treatment zone 14. Pressure applicator 40 includes a baseplate 42 and a knob or dial 44.

Waist strap 32 connects to pressure applicator 40 on lateral ends of baseplate 42 and extends circumferentially around abdomen 12 of subject 10. Waist strap 32 may vary in width and thickness and may be adjustable to accommodate various sized wearers. In the embodiment shown in FIGS. 1A and 1B, waist strap 32 includes two straps 32a, 32b that connect to one another via a clip, slide and/or buckle 34 on a dorsal side of subject 10. Buckle 34 may be a ladder lock buckle, e.g., a buckle including a slide, for coupling straps together and for adjusting a length of one or each strap 32a, 32b. The buckle 34 makes putting on and removing compression device 30 easier for subject 10 and offers a simple adjustment mechanism for customization to subject 10. In some implementations, straps 32a, 32b may be independently adjustable. In this implementation, straps 32 are inelastic and do not offer much give or stretch so straps 32 do not stretch out when pressure is applied. In other implementations, waist strap 32 may be elastic or otherwise adjustable, for example, via snaps, hook and loop fasteners or hook and eye fasteners. In further implementations the waist strap 32 may be incorporated into a garment or undergarment or be worn over or under garments or undergarments. In various implementations, buckle 34 may be located on a ventral side or dorsal side of subject 10.

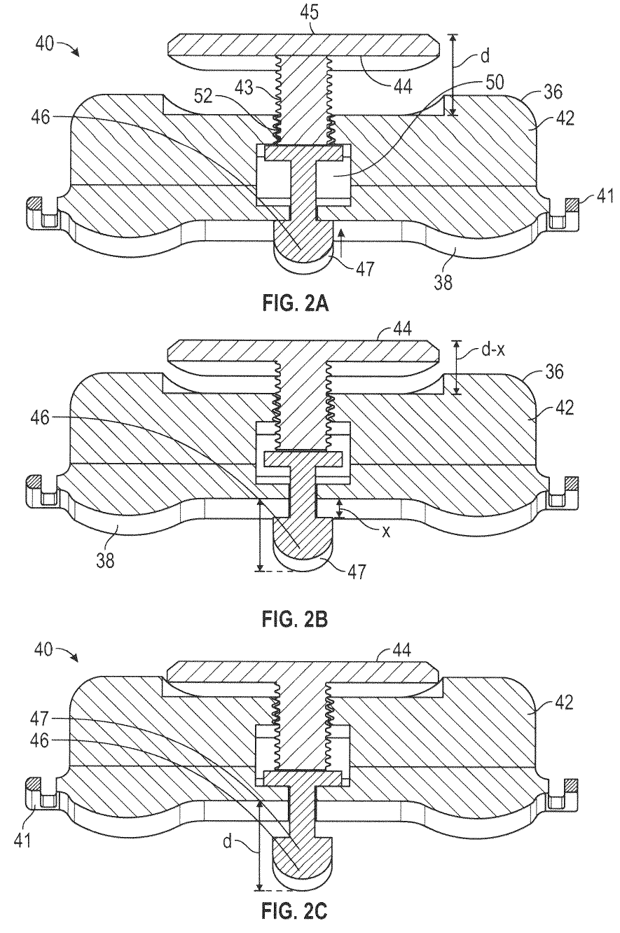

FIGS. 2A to 2C illustrate pressure applicator 40 in a disengaged configuration, an engaged configuration and a fully engaged configuration, respectively. Pressure applicator 40 includes baseplate 42, dial 44 coupled to a pad, plunger or piston 46, and brackets 48. Brackets 48 are used to connect straps 32 to pressure applicator 40.

Baseplate 42 includes an opening 50 extending from a front side 36 of baseplate 42 to a back side 38 of baseplate 42. A threaded portion 43 of dial 44 extends into opening 50 toward back side 38 while a face 45 of dial 44 remains adjacent front surface 36 during operation of compression device 30. Opening 50 includes a threaded portion 52. Threaded portion 43 and threaded portion 52 have complementary threads for coupling together.

During operation, dial 44 is turned to move a head 47 of piston 46 away from back side 38 of baseplate 42 and toward subject 10. Dial 44 is turned until piston 46 applies the desired compression pressure to treatment zone 14 of subject 10. Once compression device 30 is securely fit to subject 10, the amount of pressure applied by piston 46 is controlled by dial 44 and subject 10 since straps 32 do not stretch or yield by a measurable significance. The dial 44 can be configured to be manually adjusted by the subject 10. Subject 10 selects and controls an amount of pressure applied by piston 46 by turning dial 44 in either direction. In various implementations, pressure applicator 40 is pneumatic and dial 44 and piston 46 are pneumatically operated.

In the disengaged position illustrated in FIG. 2A, dial 44 extends a distance d away from front side 36 of baseplate 42 and piston 46 exerts little to no pressure on subject 10. Piston 46 may be adjacent back side 38 of baseplate 42 or designed to fit within a cavity or indentation on the back side 38 of baseplate 42.

In an engaged position illustrated in FIGS. 2B, dial 44, starting from an initial, disengaged position at a distance d away from baseplate 42, has been turned such that dial 44 is closer to front side 36 by a distance x. Consequently, piston 46 now extends a distance x away from a back side 38 of baseplate 42 and exerts some amount of pressure on subject 10. If the subject would like to increase the amount of pressure applied thereto, the subject can continue turning dial 44 to increase the amount of pressure applied by piston 46. If the subject would like to decrease the amount of pressure applied thereto, the subject can turn dial 44 in the opposite direction to decrease the amount of pressure applied by piston 46.

FIG. 2C shows a fully engaged position in which dial 44 nearly abuts baseplate 42 and piston 46 extends a maximum distance d away from a back side 38 of baseplate 42. In this position, pressure applicator 40 applies a maximum amount of pressure to subject 10 because piston 46 extends the distance d away from back side 38 of baseplate 42 into abdomen 12 of subject 10. In some implementations, the amount of pressure applied to subject 10 is from 20 to 40 mmHg. In various implementations, a maximum amount of pressure applied can be from 95 to 140 mmHg (and possibly up to 150 mmHg). Generally, a subject can tolerate a higher amount of pressure when the pressure is applied to a smaller, focused arca. Consequently, the size and configuration of piston head 47 may impact the amount of pressure applied or needed. For example, pressure applicator 40 may be configured such that a smaller piston head applies a larger amount of pressure to a smaller treatment zone and a larger piston head applies less pressure to a larger treatment zone to achieve similar results.

In this manner, subject 10 can regulate the amount of pressure applied to the treatment zone 14 (above or at the umbilicus region) of their abdomen 12 by pressure applicator 40 with minimal effort by turning dial 44. When pressure is needed, for example, upon standing, the subject can increase pressure by turning dial 44 in a first direction and when pressure is no longer needed, for example, upon sitting or lying down, the subject can decrease the pressure by turning dial 44 in a second direction. Implementations of the compression device according to the present disclosure differ from typical abdominal binders because the pressure is focused to a smaller area in the treatment zone 14, unlike traditional abdominal binders that compress the entire midsection. Specifically, piston head 47 may apply pressure to a one square inch area in the treatment zone of the subject. Pressure applied to the one square inch arca may range from 95 to 150 mmHg.

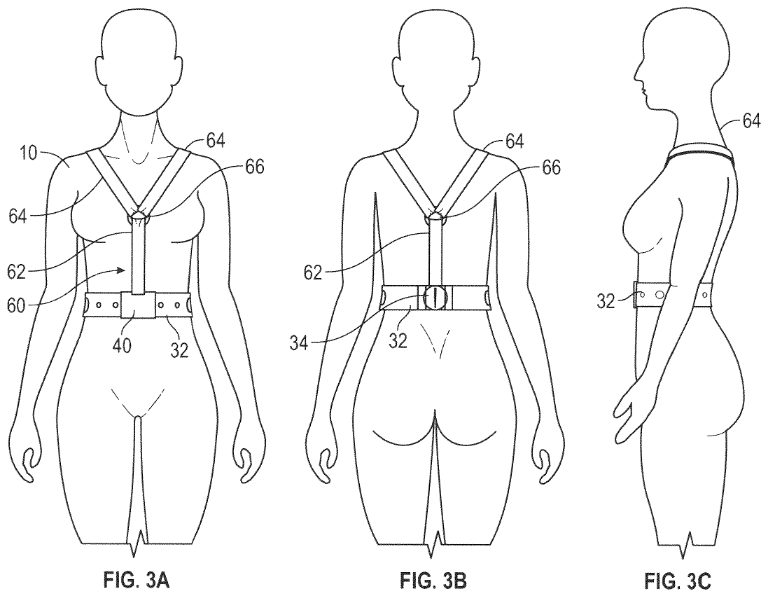

FIGS. 3A, 3B and 3C illustrate an implementation of an optional harness 60 on a wearer for use with the compression device 30 of FIG. 1A. Harness 60 includes a plurality of straps 62, 64 coupled via connectors 66. Straps 62 attach on one end to strap 32 and on the other end to a connector 66. Straps 64 attach on one end to a connector 66 on a ventral side of subject 10 and on the other end to a connector 66 on a dorsal side of subject 10. Each strap 62, 64 may be independently adjustable to accommodate various sized wearers. Straps 62, 64 may be coupled together by buckles, clips or connectors 66 so the straps 62, 64 are casy for subject 10 to adjust and to take on and off. Straps 32, 62, 64 may vary in width and thickness and may be designed to provide comfort when worn by subject 10. Straps 32, 62, 64 may be washable or easy to clean. Straps 62, 64 may be made of an inclastic material so the straps 62, 64 do not stretch out when pressure is applied.

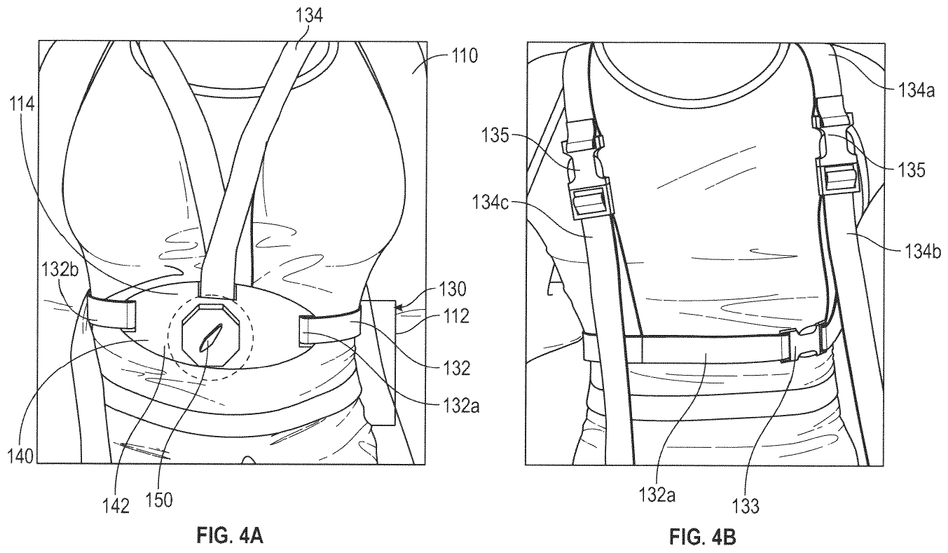

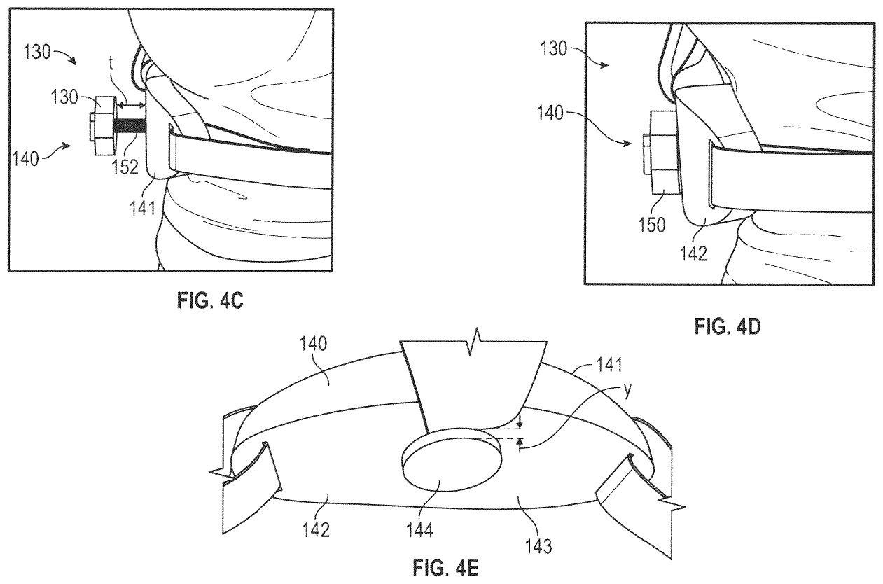

FIGS. 4A and 4E illustrate an example prototype compression device on according to an implementation of the present disclosure. Compression device 130 includes an adjustable waist strap 132, an adjustable shoulder strap 134 and a pressure applicator 140. Straps 132, 134 support pressure applicator 140 adjacent treatment zone 114 indicated by dotted lines on a ventral side of the abdomen 112 of subject 110. Pressure applicator 140 includes a baseplate 142 and a knob or dial 150. As illustrated in FIGS. 4A and 4B, shoulder strap 134 includes a harness style design which may accommodate a broader range of body habitus.

Waist strap 132 connects to pressure applicator 140 on lateral ends of baseplate 142 and extends circumferentially around abdomen 112 of subject 110. Waist strap 132 may be adjustable to accommodate various sized wearers. In the embodiment shown in FIGS. 4A and 4B, waist strap 132 includes two straps 132a, 132b that connect to one another via a clip, slide and/or buckle 133 on a dorsal side of subject 110. Bucklel 33 may be a ladder lock buckle, e.g., a buckle including a slide, for coupling straps together and for adjusting a length of one or each strap. The buckle 133 makes putting on and removing the compression device 130 casier for subject 110 and offers a simple adjustment mechanism for customization to subject 110. In some implementations, straps 132a, 132b may be independently adjustable. In the implementation shown in FIGS. 3A and 3B, a length of strap 132a is fixed and a length of strap 132b is adjustable to accommodate the subject 1 10 via ladder lock buckle 133. Subject 110 may tighten or loosen waist strap 132 by pulling on strap 132b or releasing the strap 132b at buckle 133. In this implementation, straps 132 are inelastic and do not offer much give or stretch. In other implementations, waist strap 132 may be elastic or otherwise adjustable, for example, via snaps, hook and loop fasteners or hook and eye fasteners. In further implementations the waist strap 132 may be incorporated into a garment or undergarment or be worn over or under garments or undergarments. In various implementations, buckle 133 may be located on a ventral side or dorsal side of subject 110. In additional implementations, both straps 132a and 132b may be adjustable.

Shoulder strap 134 extends from pressure applicator 140 over the shoulders of subject 110 and secures to waist strap 132 on a dorsal side of subject 110. Shoulder strap 134 may be adjustable to accommodate various sized wearers. As shown in FIG. 3B, shoulder strap 134 includes three straps 134a, 134b, 134c coupled together by buckles or clips 135 so the shoulder strap 134 is easy for subject 110 to adjust and to take on and off. In some implementations, straps 134a, 134b, 134c may be independently adjustable. In the implementation shown in FIGS. 3A and 3B, a length of strap 134a is fixed and a length of straps 134b, 134c are adjustable to accommodate the subject 110 via ladder lock buckles 135. The wearer (e.g., subject 110) may tighten or loosen shoulder strap 134 by pulling on straps 134b, 134c or releasing the straps 134b, 134c at buckles 35. In other implementations, shoulder strap 134 may be otherwise adjustable, for example, via snaps, hook and loop fasteners or hook and eye fasteners. In various implementations, buckle 135 may be located on a ventral side or dorsal side of subject 110. In additional implementations, straps 134a, 134b and 134c may be adjustable. In some implementations, shoulder strap 134 may be securable to a garment or undergarment, may be incorporated into a garment or undergarment or be worn over or under garments or undergarments. In further implementations, shoulder strap 134 may not extend over the shoulder of a wearer.

In the embodiment shown in FIGS. 4A and 4B, subject 110 may take the compression device 130 off by opening clip 133 and pulling their arms out of loops created by shoulder strap 134 and waist strap 132. Subject 110 may put compression device 130 on by opening clip 133 and placing their arms in the loops created by shoulder straps 134 and waist strap 132. Straps 132, 134 may be adjusted prior to or after subject 110 puts on compression device 130.

Waist strap 132 and shoulder strap 134 may vary in width and thickness and may be designed to provide comfort when worn by subject 110. Straps 132, 134 may be casy to clean and/or made of a washable material. In some embodiments, a single waist strap 132 may sufficiently support pressure applicator 140. In other embodiments, a single shoulder strap 134 may sufficiently support pressure applicator 140. In further embodiments, at least one strap may be used with another support to position pressure applicator 140 adjacent treatment zone 114. Straps 132, 134 may be made of an inelastic material so the straps 132, 134 do not stretch out when pressure is applied.

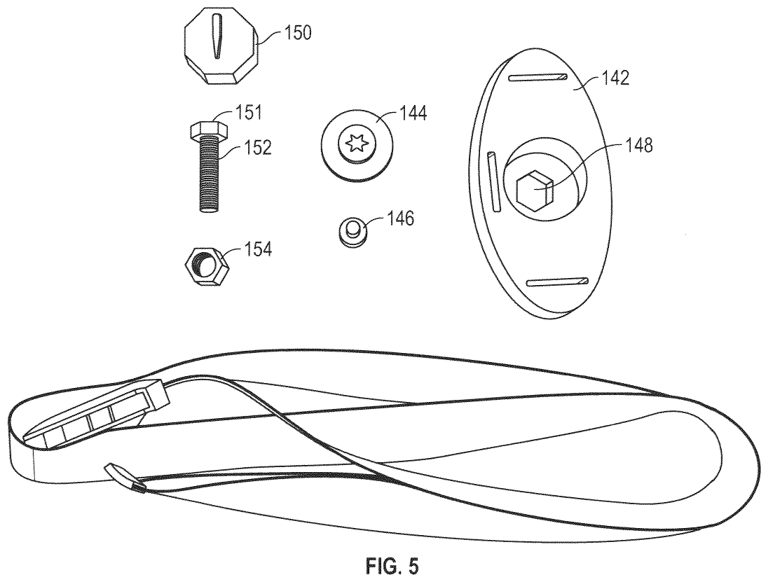

FIGS. 4C and 4D illustrate side views of the prototype compression device 130 in disengaged and engaged configurations, respectively. FIG. 4E illustrates a perspective view of compression device 130 in a second engaged configuration. FIG. 5 illustrates components of the compression device 130 and pressure applicator 140 including baseplate 142 having an opening 148, a plunger disc or a pressure pad 144, a connector 146, dial 150, a threaded bolt 152 and a threaded nut 154. Bolt 152 and nut 154 have complementary threads for coupling together.

Referring now to FIGS. 4A to 4E and 5, dial 150 is fixedly connected to a head 151 of bolt 152. Nut 154 is affixed to opening 148 of baseplate 142 to provide a threaded opening in baseplate 142. Bolt 152 engages nut 154 via complementary threads so bolt 152 extends from a front side 141 of baseplate 142 through opening 148 to a backside 143 of baseplate 142. Dial 150 remains adjacent the front side 141 of baseplate 142 during operation of compression device 130. A disc or pressure pad 144 is coupled to an end of bolt 152 opposite dial 150.

During operation, dial 150 is turned to thread bolt 152 through nut 154 so pressure pad 144 moves toward subject 110 and applies compression pressure to treatment zone 114 of subject 110. Once compression device 130 is securely fit to subject 110, the amount of pressure applied by pressure pad 144 is controlled by dial 150 and subject 110 since the straps 132, 134 do not stretch or yield by a measurable significance. The dial 150 can be configured to be manually adjusted by the subject 110. The subject 110 selects and controls the amount of pressure applied by pressure pad 144 by turning dial 150 in either direction.

In the disengaged position illustrated in FIG. 4C, dial 150 extends a distance t away from front side 141 of baseplate 142 and pressure pad 144 exerts little to no pressure on subject 110. Pressure pad 144 maybe adjacent a back side 143 of baseplate 142 or designed to fit within a cavity or indentation on the back side 143 of baseplate 142.

In an engaged position, dial 150 is less than a distance d away from front side 141 of baseplate 142 and pressure pad 144 exerts an amount of pressure on subject 110. FIG. 4D shows an engaged position in which dial 150 abuts baseplate 142 and pressure pad 144 extends the distance t away from a back side 143 of baseplate 142. In this position, pressure applicator 140 applies a maximum amount of pressure to subject 110 because pressure pad 144 extends the distance t away from back side 143 of baseplate 142 into the abdomen 112 of subject 110. In some implementations, the amount of pressure applied to subject 110 is from 20 to 40 mmHg. In various implementations, a maximum amount of pressure applied can be from 95 to 150 mmHg when the size of the treatment zone is small, for example, approximately one square inch.

In a second engaged position illustrated in FIG. 4E, dial 150, starting from an initial, disengaged position at a distance t away from baseplate 142, has been turned such that dial 150 is closer to front side 141 by a distance y. Consequently, pressure pad 144 now extends a distance y away from a back side 143 of baseplate 142 and exerts some amount of pressure on subject 110 in an engaged position. If the subject would like to increase the amount of pressure applied thereto, the subject can continue turning dial 150 to increase the amount of pressure applied by pressure pad 144. If the subject would like to decrease the amount of pressure applied thereto, the subject can turn dial 150 in the opposite direction to decrease the amount of pressure applied by pressure applicator 144.

In this manner, subject 10 can regulate the amount of pressure applied to the abdomen by pressure applicator 140 with minimal effort by turning dial 150. When pressure is needed, for example, upon standing, the subject can increase pressure by turning dial 150 in a first direction and when pressure is no longer needed, for example, upon sitting or lying down, the subject can decrease the pressure by turning dial 150 in a second direction. Implementations of the compression device according to the present disclosure differ from typical abdominal binders because the pressure is focused just below the diaphragm, unlike abdominal binders that compress the entire midsection.

Compression devices 30, 130 are abdominal compression belts that apply pressure above, at or below the umbilicus region of the abdomen to relieve symptoms of subjects with POTS, OH and NOH. Compression devices 30, 130 are lower profile than conventional devices and advantageously also allows the subject to adjust the pressure being applied. Compression devices 30, 130 are also adaptable to a broader range of body habitus given the harness design. These features allow the subjects to keep the compression devices 30, 130 on during the day and to apply pressure as needed. Components of compression devices 30, 130 including pressure applicator 140 may be 3D printed. It should be understood that the thickness of pressure applicator 140 can be selected for desired garment profile and/or constraints of the materials used.

In addition to or as alternative to straps, pressure applicators may be securable to garments or undergarments. In some implementations, pressure applicators may connect to a brassiere for placement adjacent treatment zone. In other implementations pressure applicators may be incorporated into garments or undergarments or be worn over or under garments or undergarments.

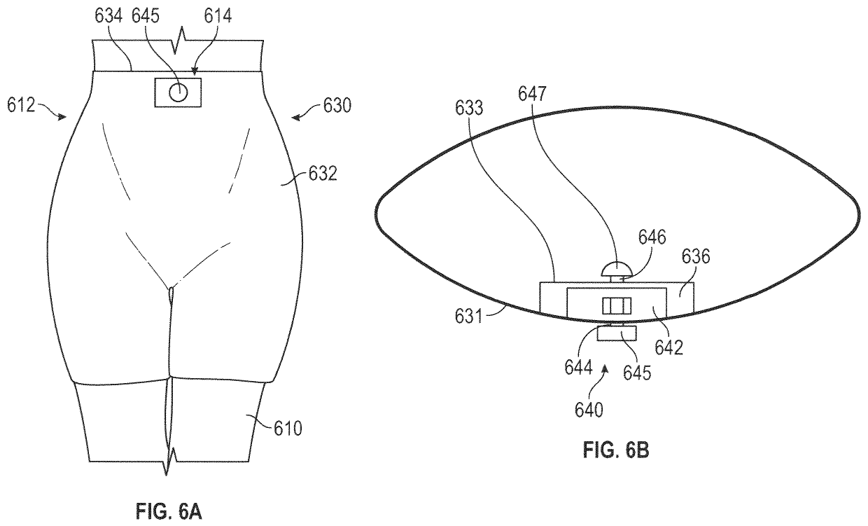

FIGS. 6A and 6B illustrate an example prototype of a compression device including a compression garment on a wearer. FIG. 6A illustrates a front view of compression device 630 and FIG. 6B illustrates a top view of compression device 630. Compression device 630 includes a support garment 632 to be worn around a subject's 610 abdomen 612. A treatment zone 614 may be at or above an umbilicus region of abdomen 612. Compression garment 632 includes a pocket 636 housing at least a portion of pressure applicator 640 therein. The pocket 636 is arranged to position pressure applicator 640 in an area adjacent to a treatment zone 614 of subject 610. In some implementations, pocket 636 may be at or near a waistband 634 of garment 632. Pressure applicator 640 may be similar to pressure applicator 40 and include baseplate 642, dial 644, piston 646, and opening 650, and operate in a similar manner as pressure applicator 40 as explained above.

In some implementations, baseplate 642 is supported inside pocket 636 of compression garment 632. Dial 644 remains adjacent an exterior side 631 of garment 132 and piston head 647 remains adjacent an interior side 633 of garment 632, dial 144 extends through an opening in the exterior side 631 of garment through pocket 636 and piston 646 extends out an opening in the interior side 633 of garment 632. Subject 610 controls the amount of pressure being applied to their abdomen 612 by pressure applicator 640 by turning dial 644. When subject 610 turns dial 644 in a first direction, dial 644 moves toward subject 610 so piston 646 applies a compression pressure to the treatment zone 614. When the subject turns dial 644 in the opposite direction, piston 644 moves away from subject 610 so pressure applied to abdomen 612 decreases. In some implementations, the amount of pressure applied to subject 610 is from 20 to 40 mmHg. In various implementations, a maximum amount of pressure applied can be from 95 to 150 mmHg when the size of treatment zone 614 is small, for example, approximately one square inch.

Compression garment 632 may be made of a washable material and a compression material. Compression garment 632 may be made of materials known to make shapewear, undergarments, compression stockings, compression socks, for example. Compression garment 632 may have a compression pressure of 5 to 20 mmHg from which additional pressure is able to be applied using the pressure applicator and pressure regulator. Designs of compression garment 132 may include a variety of styles and include, for example, underwear, briefs, bicycle shorts, thigh shorts, briefs, a wide band, tank tops, camisoles, tube tops, shirts or tops, or hosiery. In various implementations, compression garment 632 may have a gripping material, e.g. silicone or silicone rubber, on the interior side 633 so the garment 632 remains in a desired position despite movement of subject 610.

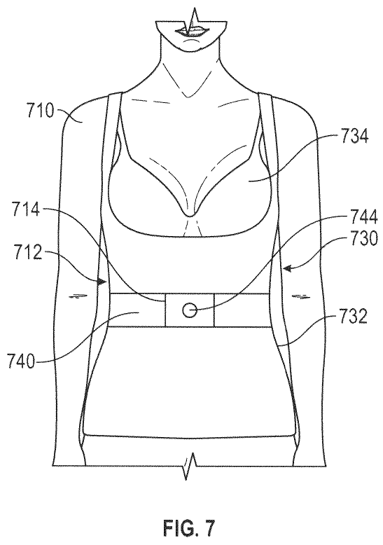

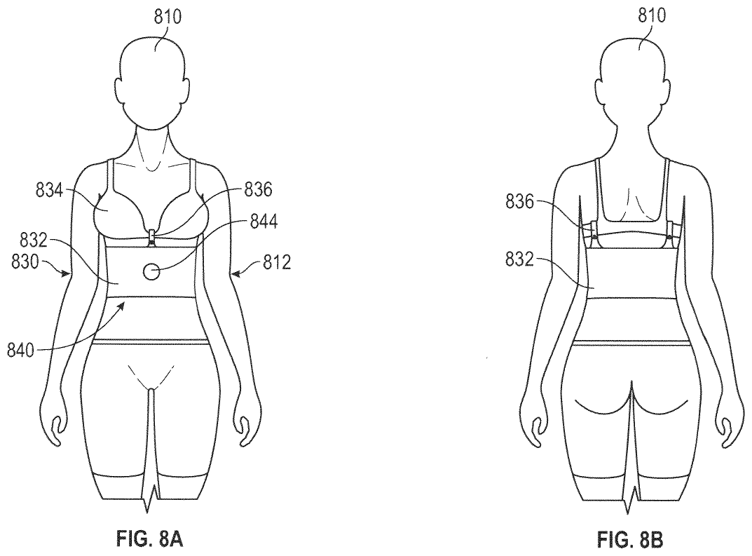

FIG. 7 illustrates an example prototype of a compression device including a compression garment on a wearer. Compression device 730 includes a support garment 732 to be worn around a subject's 710 abdomen 712. Compression garment 732 may be a camisole or tank top style garment that may be configured to be worn with or without a separate brassiere 734. A treatment zone 714 may be at or above an umbilicus region of abdomen 712. Compression garment 732 supports at least a portion of pressure applicator 740 in an area adjacent to a treatment zone 714 of subject 710. Compression garment 732 may include a pocket or housing to support pressure applicator 740. Pressure applicator 740 may be similar to pressure applicator 40 and include baseplate 742, dial 744, piston 746, and opening 750, and operate in a similar manner as pressure applicator 40 as explained above. In some implementations, baseplate 742 is supported inside pocket of compression garment 732. Dial 744 remains adjacent an exterior side 731 of garment 732 and piston head remains adjacent an interior side of garment 732. Subject 710 controls the amount of pressure being applied to their abdomen 712 by pressure applicator 740 by turning dial 744. When subject 710 turns dial 744 in a first direction, dial 744 moves toward subject 710 so pressure applicator 740 applies a compression pressure to the treatment zone 714. When the subject turns dial 744 in the opposite direction, pressure applied to abdomen 712 decreases.

FIGS. 8A and 8B illustrate an example prototype of a compression device including a compression garment on a wearer. Compression device 830 includes a support garment 832 to be worn around a subject's 810 abdomen 812. Compression garment 832 may be a wide band or waist trainer and may be adjustable for a customizable fit. Compression garment 832 is configured to attach to a separate brassiere 834 via fasteners 836. As illustrated in the implementation shown in FIGS. 8A and 8B, one fastener 836 is on a ventral side of subject 810 and two fasteners are on a dorsal side of subject 810. Compression garment 832 supports pressure applicator 840 in an area adjacent to a treatment zone 814 of subject 810 and may include a pocket or housing for supporting at least a portion of pressure applicator 840 therein. Pressure applicator 840 may be similar to pressure applicator 40 and operate in a similar manner as pressure applicator 40 as explained above. Dial 844 remains positioned on an exterior side of garment 832 and piston head remains adjacent an interior side of garment 832. Subject 810 controls the amount of pressure being applied to their abdomen 812 by pressure applicator 840 by turning dial 844. When subject 810 turns dial 844 in a first direction, dial 844 moves toward subject 810 so pressure applicator 840 applies a compression pressure to the treatment zone 814. When the subject turns dial 844 in the opposite direction, pressure applied to abdomen 812 decreases.

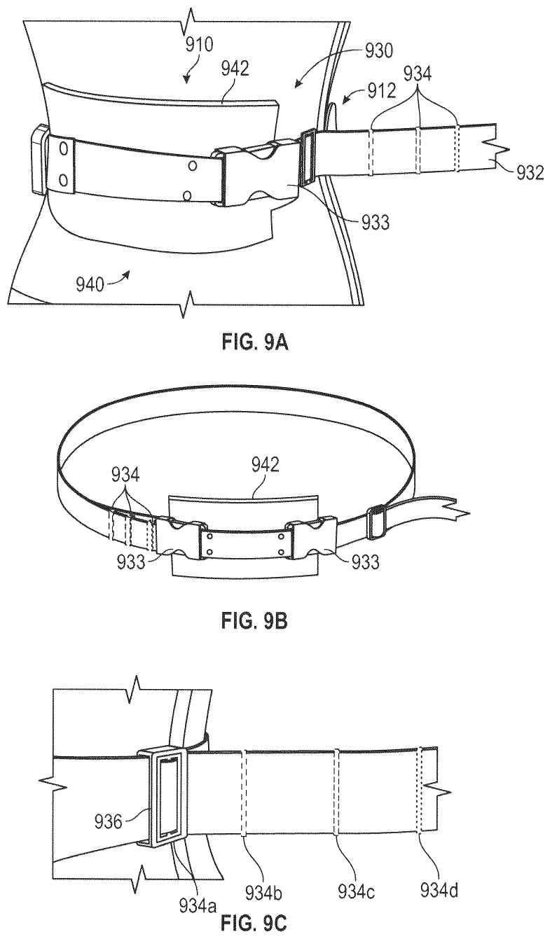

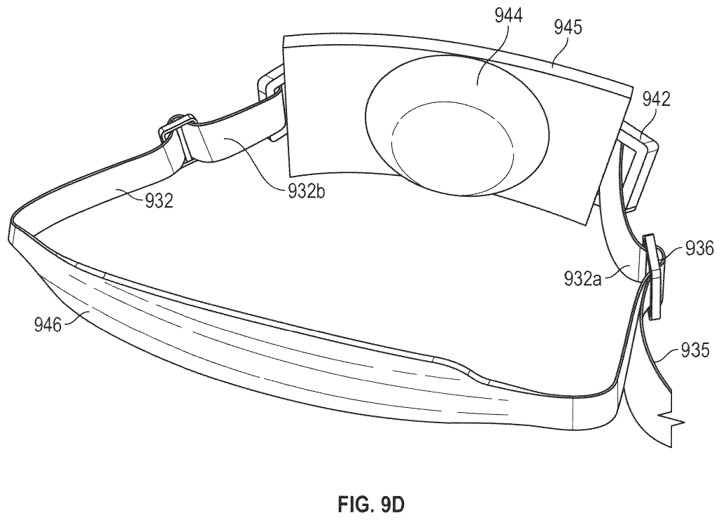

FIG. 9A illustrates an example of a compression device on a wearer having calibrated markings. FIGS. 9B and 9C illustrate example straps of the compression device of FIG. 9A with calibration markings. FIG. 9D illustrates a perspective view of the compression device of FIG. 9A.

Referring now to FIGS. 9A to 9D, compression device 930 includes at least one support or strap 932 and a pressure applicator 940 for applying pressure to a ventral side of abdomen 912 of subject 910. In some embodiments, compression device 930 includes at least two straps 932. Pressure applicator 940 includes a baseplate 942 having a pressure pad 944 fixedly coupled to an interior side 943 of baseplate 942 when compression device 930 is on subject 910. Pressure pad 944 protrudes from baseplate 942. In various implementations, pressure pad 944 is made of a firm foam or firm plastic material. In various implementations, a dorsal support 946 may be coupled to straps 932. The dorsal support 946 may be positioned against a lower back of subject 910 to make compression device 930 more comfortable for subject 910. The dorsal support 946 may include a pad or be an extension or expansion of straps 932.

Straps 932 may be coupled to baseplate 942 via buckles 933. Straps may include one strap 932 on lateral sides of baseplate 942 for securing compression device 930 to subject 910. As illustrated in FIGS. 9A to 9D, straps 932 are coupled to baseplate 942 via buckles 933. Straps 932 may be pulled on a free end 935 by subject 910 to adjust the fit and position of compression device 930. Straps 932 may be adjustable via a slide, buckle, clip or ladder lock buckle for example.

In an embodiment of compression device 930, straps 932 include markings or demarcations 934 and an indicator slide or clip 936 to regulate the amount of pressure applied to the subject. The markings 934 are calibrated so subject 910 can adjust straps 932 to achieve a desired and/or therapeutic abdominal pressure. Subject 910 moves indicator clip 936 to the desired marking 934 that corresponds to the desired pressure and secures straps 932 in this position. The fit of straps 932 together with pressure pad 944 applies the selected pressure to the abdomen 912 of subject 910. In order to change the pressure (increase or decrease), subject 910 can release the straps 932 and/or move the indicator clip 936 to a second marking 934 and secure straps 932 at second marking 934. Straps 932 are made of an inelastic material so the straps do not stretch or give when pressure is applied by pressure pad 944.

In some implementations, the demarcation or markings 934 are different colors. As shown in FIG. 9C, marking 934a is a first color (e.g., green), marking 934b is a second color (e.g., yellow), marking 934c is a third color (e.g., red) and marking 934d is a fourth color (e.g., blue). The colored markings 934 serve as visual indicators for subject 910; while pulling straps 932, subject 910 can visually comprehend how much force has been applied by looking at color markings 934 on straps 932. Markings 934 may also help subject 910 remember how tightly to pull straps 932, e.g., subject 910 may recall that red marking 934c is selected for their body habitus. Subject 910 may change the desired position of indicator clip 936 and straps 932 with case based on a doctor's suggestions or their own activities. For example, subject 910 may loosen calibrated straps 932 to reduce pressure when the subject9 moves from standing to lying down or subject 910 may tighten calibrated strap 932 to a desired marking 934 to increase the pressure when subject 910 moves from lying down to standing.

In some examples, straps 932 may be calibrated to indicate a therapeutic pressure, for example, 40 mmHg for various body habitus including a range of waist sizes or waist circumferences, for example, 26 to 32 inches. Table 1, shown below, provides examples of markings 934 that are calibrated to provide a therapeutic pressure of 40 mmHg for a given waist size for compression device 930. Subjects may use compression device 930 with ease by looking up their waist size on Table 1 to determine which color demarcation 934a, 934b, 934c, 934d to align with indicator clip 936. As a result, subjects of varying body habitus can achieve the desired 40 mmHg of therapeutic pressure with ease. In other examples, straps 932 may be calibrated to indicate a range of pressures, for example, from 20 mmHg to 40 mmHg, for a single waist circumference, for example, 30 inches. In these examples, subjects can select a desired pressure from markings 934 with respect to their waist circumference. Table 2, shown below, provides examples of markings for a given waist size (circumference). In further examples, a combination of the former and latter examples may be employed.

TABLE 1
Example markings for varying waist sizes.

| | Setting for Therapeutic |
|---|---|
| Waist Size (inches) | Pressure (40 mmHg) |
| 26 | Green 934a |
| 28 | Yellow 934b |
| 30 | Red 934c |
| 32 | Blue 934d |

TABLE 2
Example markings for a single waist size of 30 inches.
Waist Size 30 inches

| Therapeutic Pressure | |
|---|---|
| (mmHg) | Marking |
| 20 | Red |
| 30 | Yellow |
| 40 | Green |

Referring to FIG. 9D, baseplate 942 supports pressure pad 944 which is fixedly connected thereto such that pressure pad 944 is removable and replaceable. A backside 945 of pressure pad 944 and backside 943 of baseplate 942 may include hook and loop fasteners for easy removal and replacement. Other couplers or fasteners may also be used. Pressure pad 944 may be replaced with pads of various shapes, sizes, rigidities, and densities/firmness for variations and customizations in applying pressure to subjects. In some examples, a firmer, more rigid, or thicker pad may be used to apply more pressure given the same amount of force has been pulled on straps. In other examples, a thinner, less rigid, or softer pad may be used to apply less pressure given the same amount of force has been pulled on straps. In further examples, the pressure pad may have a small size to target a specific area in the treatment zone of the subject. In some examples, pad 244 and straps 232 are made of washable material.

As illustrated in FIGS. 9A and 9D, compression device 930 has a thin profile particularly along the lateral sides, making device 930 comfortable and easier for a subject to use and wear throughout the day. Compression device 930 may be used over or under clothing.

Compression device 930 can support patients with POTS because compression device 930 applies sufficient pressure to abdomen 912 to keep subject 910 standing without symptoms. In addition to compression device 930, a pressure measuring device or pressure gauge may be used to measure the pressure being applied by pressure applicator 940 at abdomen 912 and/or to ensure a desired pressure is being maintained. In various implementations, a pressure gauge and/or electronic sensors or gauges may work together with an application on a smartphone, watch or personal device to provide feedback to the subject regarding pressure applied to the subject and the subject's blood pressure.

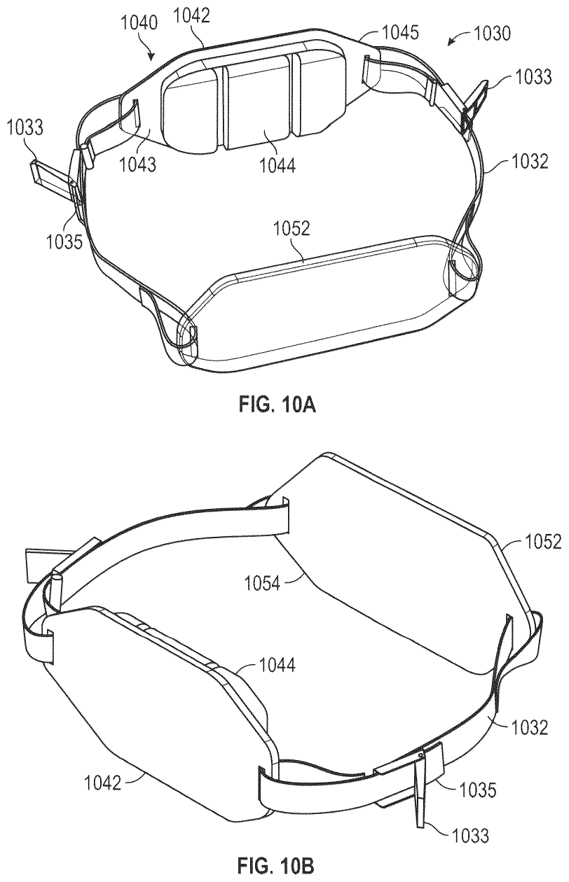

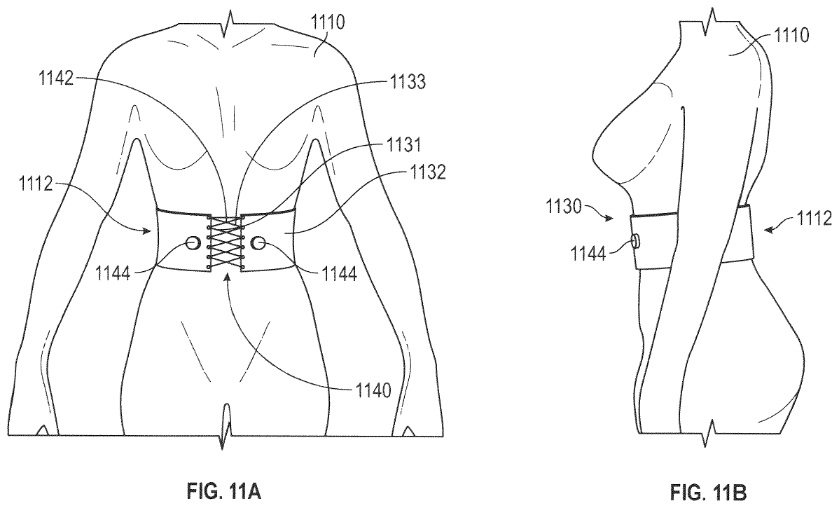

FIG. 10A and FIG. 10B illustrate an example of a compression device having removable pads. Compression device 1030 includes straps 1032 connected to pressure applicator 1040. Pressure applicator 1040 includes a pressure pad 1044 removably coupled to a backside 1043 of ventral baseplate 1042 via hook and loop fasteners, other couplers or other fasteners. Straps 1032 are made of an inelastic material and connect to baseplate 1042 via slots 1045 on lateral ends of baseplate 1042. Straps 1032 are adjustable by pulling on a free end 1035 and securing in place with buckles 1033. Buckles 1033 may include box frame buckles or ladder lock buckles, for example, which provide convenient adjustment while maintaining the straps taut. Pressure pad 1044 applies pressure to the abdomen of the subject when straps 1032 are pulled taut.

Compression device 1030 also includes a dorsal baseplate 1052 having a dorsal pad 1054 removably coupled thereto. Dorsal pad 1054 may be ergonomically designed for optimal back support of a subject. Pressure pad 1044 and dorsal pad 1054 work together to relieve stress towards the medial direction while ensuring the desired amount of compression is exerted towards the posterior direction. Dorsal pad 1054 may be removably coupled to dorsal baseplate 1052 via hook and loop fasteners, other couplers or other fasteners.

Pressure pad 1044 and dorsal pad 1054 may be replaced with pads of various shapes, sizes, rigidities, and densities/firmness for variations and customizations in applying pressure to subjects. In some examples, a firmer, more rigid, or thicker pad may be used to apply more pressure given the same amount of force has been pulled on straps. In other examples, a thinner, less rigid, or softer pad may be used to apply less pressure given the same amount of force has been pulled on straps. In further examples, the pads may have a smaller size to target a specific area of the subject. In some examples, pads and straps are made of washable material. Advantageously, compression device 1030 is configured so the components including straps 1032, buckles 1033 and pressure applicator 1040 including dorsal pad 1054 and dorsal baseplate 1052 can be easily removed and replaced when a single component fails or is no longer suitable for its intended purpose.

FIGS. 11A and 11B illustrate an example of a compression device on a wearer. Compression device 1130 includes a binder or waist garment 1132 extending circumferentially around an abdomen 1112 of a subject 1110. Garment 1132 includes ends 1131 and 1133. Garment 1132 supports pressure applicator 1140 on a ventral side of the abdomen 1112 of subject 1110. Pressure applicator 1140 includes lacing 1142. Lacing 1142 connects end 1131 to end 1133 to keep garment 1132 fitted around subject 1110. The pressure regulator for the pressure applicator 1140 includes knobs 1144. Knobs 1144 are used to adjust and control a width or tightness of lacing 1142. The lacing 1142 and/or knobs 1144 can include markings or notches indicating corresponding amounts of titrated pressure. In some cases, a pad may be included between the lacing and the subject for further targeting of a treatment zone.

When lacing 1142 is tightened, ends 1131, 1133 are pulled closer to one another and pressure is applied to abdomen 1112 of subject 1110. The treatment zone of the pressure can be between 10 to 20 square inches or higher, depending on area covered by lacing 1142. When lacing 1142 is loosened or released, pressure on the abdomen decreases. In this implementation, pressure applicator 1140 is configured to apply pressure to abdomen 1112 by tightening or cinching garment 1132. As a result, pressure is applied circumferentially around the abdomen by garment 1132. Garment 1132 may vary in width and thickness. Garment 1132 may be made of an inelastic material that does not give or stretch out such that pressure applicator 1140 can control the amount of pressure applied to subject 1110 by controlling how tightly or loosely garment 1132 is worn by subject 1110. Therapeutic ranges of pressure may go up to 40 mm Hg, for example, or up to 60 mm Hg, for example.

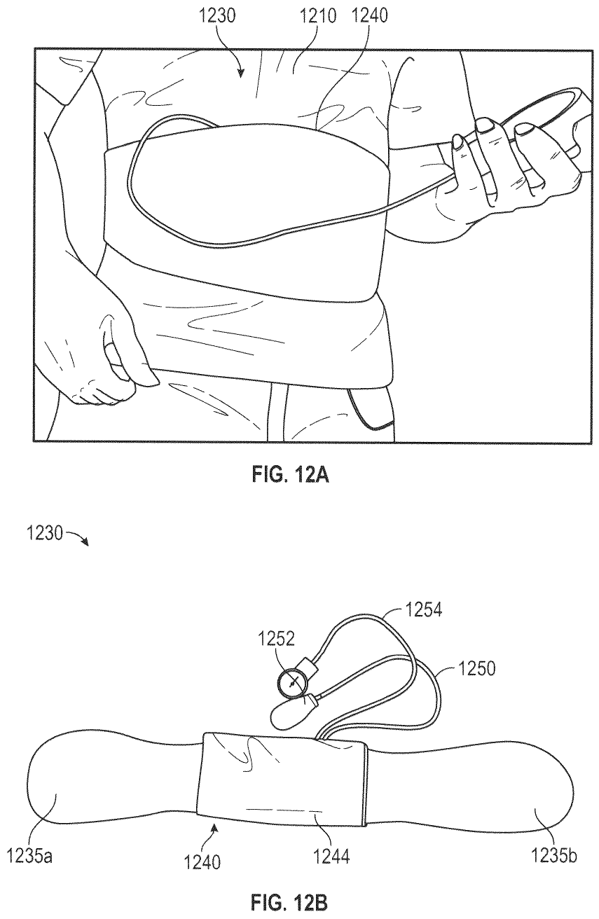

FIGS. 12A and 12B illustrate an example of a compression device having an inflatable bladder. Compression device 1230 includes a belt 1232 and a pressure applicator 1240 having an inflatable bladder 1244. Belt 1232 may wrap around the abdomen of a subject 1210 and secure onto itself via fasteners or couplers which may include, for example, hook and loop fasteners, buckles, clips, straps or any combination thereof. As illustrated in FIGS. 12A and 12B, belt 1232 includes hook and loop fasteners on ends 1235 thereof so one end 1235a of belt 1232 may be fastened to another end 1235b of belt 1232 by overlapping the ends 1235a, 1235b and applying a slight pressure. To separate belt 1232, one end 1235a may be pulled apart from the other end 1235b. In some implementations, belt 1232 may be similar in style and design to a weightlifting belt. In other implementations, belt 1232 may be made of material having sufficient friction so belt 1232 does not slip when worn on subject 410. Belt 1232 may also be made of a material and fasteners that make belt 1232 easy to put on, take off and adjust. Additional straps, buckles, fasteners, or clips may be provided on belt 1232 to further secure the belt 1232 on the abdomen 1212 of a subject 1210.

An inflatable bladder 1244 of pressure applicator 1240 is adjacent a treatment zone of subject 1210 when belt 1232 is secured on subject 1210 as illustrated in FIG. 12A. Belt 1232 should preferably fit snugly or be taut on subject 1210, while still being comfortable for subject 1210. When pressure is needed, subject 1210 can inflate air bladder 1244 via pump 1250 to a desired or select pressure as indicated on pressure gauge or barometer 1254. Once the pressure increases to the desired pressure, for example, 40 mmHg, subject 1210 can stop pumping air into inflatable bladder 1244. In some cases, the treatment zone is about 30 square inches. In some cases, a larger treatment zone is able to be affected, for example, by use of a larger inflatable bladder 1244 and/or incorporation of pressure caused by belt 1232 or attachments to belt. In addition, since belt 1232 is fastened tightly against subject 1210, the inflatable bladder 1244 applies compression pressure to the subject's abdomen 1212 locally, however, inflating the bladder 1244 also causes pressure to be applied by belt 1232 circumferentially around abdomen 1212. To decrease pressure in the inflatable bladder 1244, the subject 1210 can open release valve 1252 to reduce the pressure to a lower desired amount and/or to empty inflatable bladder 1244. Thus, compression device 1230 is easy for a subject to take on and off and position properly. Compression device 1230 is also easy for a subject to operate. Pump 1250 and release valve 1252 can be used to increase and decrease the pressure applied by pressure applicator 1240 as desired with ease. An optional barometer 1254 or a pressure gauge may be provided so the subject can see the amount of pressure in inflatable bladder 1244 and inflate or deflate bladder 1244 accordingly. Barometer 1254 may be easily detachable to compression device 1230 for convenience. Belt 1232 may be adaptable to various waist circumferences due to the adjustability of pressure in bladder 1244.

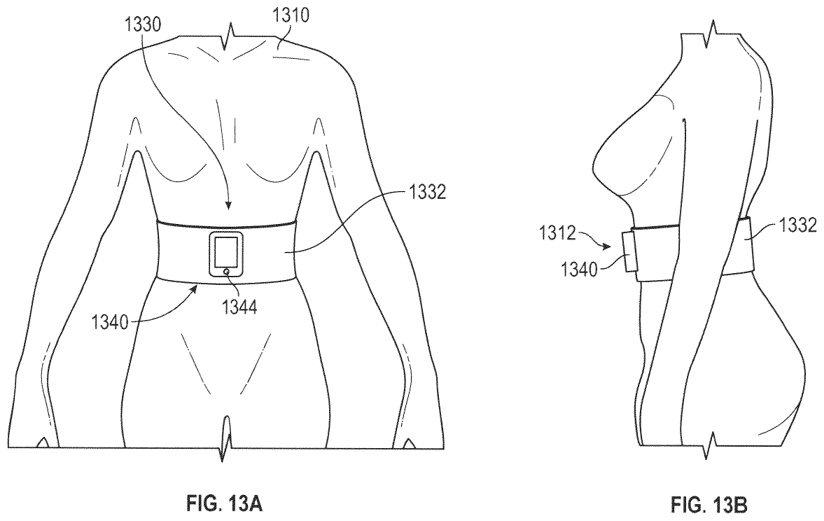

FIGS. 13A and 13B illustrate an example of a compression device having an inflatable bladder. Compression device 1330 includes a belt 1332 and a pressure applicator 1340 having an actuator 1344 for inflating and deflating an inflatable bladder. Belt 1332 may wrap around the abdomen of a subject 1310 and secure onto itself via fasteners or couplers which may include, for example, hook and loop fasteners, buckles, clips, straps or any combination thereof. An inflatable bladder of pressure applicator 1340 is adjacent a treatment zone of subject 1310 when belt 1332 is secured on subject 1310. Belt 1232 should preferably fit snugly or be taut on subject 1310, while still being comfortable for subject 1310. When pressure is needed, subject 1310 can inflate air bladder via actuator 1344 to a desired or select pressure as indicated on a pressure gauge or barometer. Once the pressure increases to the desired pressure, for example, 40 mmHg, subject 1310 can stop inflating bladder. Since belt 1332 is fastened tightly against subject 1310, the inflatable bladder 1344 applies compression pressure circumferentially around the subject's abdomen 1312.

The subject 1310 can use actuator 1344 to reduce the pressure to a lower desired amount and/or to empty inflatable bladder. Thus, compression device 1330 is easy for a subject to take on and off and position properly. Compression device 1330 is also easy for a subject to operate. Actuator 1344 can be used to increase and decrease the pressure applied by pressure applicator 1340 as desired with case. An optional barometer or a pressure gauge may be provided so the subject can see the amount of pressure in inflatable bladder and inflate or deflate bladder accordingly. Belt 1332 may be adaptable to various waist circumferences due to the adjustability of pressure in bladder 1244. Various implementations of the systems and devices of the present disclosure allow a subject to control the amount of pressure being applied and provide the subject with the power to adjust the pressure. Therapeutic ranges of pressure may go up to 40 mm Hg, for example, or up to 60 mm Hg, for example. If a subject wants less pressure, the present disclosure advantageously gives subjects the freedom and ability to control or adjust the pressure from amounts in recommended ranges to lower amounts.

Various implementations of the systems and devices of the present disclosure can further comprise optional features, for example, feedback loops, that provide enhanced control of abdominal compression and pressure. For example, the support, belt, straps or garments can include features or “smart” features that monitor patient status, automatically adjust the pressure accordingly and limit the amount of maximum pressure provided. Sensors may be employed to monitor the patient directly or indirectly and communicate with an on-board controller to change or suggest changes to the applied pressure. Some examples of patient status include, but are not limited to, changes in postural position, patient movement, user feedback, heart rate, blood pressure, and the like. Sensors can be incorporated into the devices, and/or the devices can be electronically connected to other health-monitoring devices, such as smart watches, smart phones, activity monitors, personal devices, and the like.

Non-limiting example embodiments of belts, straps, supports and garments can include an inelastic (i.e., not stretchable) fabric that is comfortable to the subject yet provides strong docking forces when locked in place. The belts, straps, supports and garments can also include fabric, leather, non-woven material, or a combination thereof. In some embodiments, the belts, straps, supports and garments comprise an optional stiffener disposed on anterior and/or posterior portions. In general, the belts, straps, supports and garments are configured to be adjustable to a specific circumference so as to apply a prescribed pressure in the treatment zone of the subject. The adjustment can be accomplished by any suitable method, such as laces, cinches, buckles, clips, hook and loop fasteners, etc. In an example, a belt is tightened by cinching lateral straps. In another example, a belt comprises one or more straps with indicators/markings for tightening guidance, such as length markers, detents, etc. Other means of adjustment will be evident to a person of skill in the art and are within the scope of the invention. The belts, straps, supports and garments lengths can be configured such that it is specific to a particular abdomen size, or it can be provided with features that allow a single item to accommodate a range of abdomen sizes.

For any of the above-mentioned configurations, the belt is designed to provide a prescribed and measurable pressure to the abdomen. In some configurations localized and focused pressure is applied to a small area (approximately one square inch) at or above the umbilical region. In other configurations, pressure is applied to a larger area (approximately 10 square inches) at, above or below the umbilical region. In yet other configurations, pressure is applied to an even larger area (up to 30 square inches or higher). Initial testing suggests that compressing an approximately 10 square inch area at a pressure of about 40 mm Hg provides relief to patients. By compressing approximately a 10 square inch area just below the diaphragm at a therapeutic pressure from 20 mmHg to 50 mmHg, for example, at 40 mmHg, multiple studies and the inventors' own testing has shown to relieve these symptoms. In other implementations, pressure is applied to a smaller, focused area that may be approximately 1 square inch with therapeutic pressures ranging from 95 to 150 mmHg.

The materials used in this design are easily mass produced, modular and low cost, making the pricing of this device quite competitive. This is a novel medical device that fills quite a large unmet need because the design fulfills several consumer requirements and effectively delivers therapeutic pressure.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinence of any of the documents cited herein. All references cited herein are fully incorporated by reference, unless explicitly indicated otherwise. The present disclosure shall control in the event there are any disparities between any definitions and/or description found in the cited references.

One skilled in the art will readily appreciate that the present disclosure is well adapted to carry out the objects and obtain the ends and advantages mentioned, as well as those inherent therein. The present disclosure described herein are presently representative of preferred embodiments, are exemplary, and are not intended as limitations on the scope of the present disclosure. It is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A compression device comprising:
at least one support;
a pressure applicator connected to the at least one support, the pressure applicator configured to apply compressive pressure to a treatment zone on an abdomen of a subject; and
a regulator for controlling the amount of compressive pressure applied to the subject by the pressure applicator, the regulator for controlling an amount of the compressive pressure from a minimum pressure to a maximum pressure as selected by the subject.

2. The compression device of claim 1, wherein the pressure applicator comprises a pressure source for applying the compressive pressure to the subject in the treatment zone.

3. The compression device of claim 1, wherein the treatment zone is a one to ten square inch area.

4. The compression device of claim 1, wherein the treatment zone is a 10 to 30 square inch area.

5. The compression device of claim 1, wherein the at least one support is a strap or a plurality of straps.

6. The compression device of claim 1, wherein the at least one support is adjustable.

7. The compression device of claim 1, wherein the pressure applicator includes a pressure pad, the pressure pad being configured to apply the compressive pressure to the treatment zone of the subject.

8. The compression device of claim 7, wherein the pressure pad is removable and replaceable.

9. The compression device of claim 7, wherein the pressure applicator includes a baseplate.

10. The compression device of claim 7, wherein the regulator is a dial, wherein the dial is configured to be adjusted by the subject to control the amount of compressive pressure applied by the pressure pad to the treatment zone of the subject.

11. The compression device of claim 10, wherein the dial is configured to be manually adjusted by subject.

12. The compression device of claim 7, wherein the at least one support includes an adjustable strap that extends around a circumference of the abdomen of the subject.

13. The compression device of claim 7, wherein the at least one support includes an adjustable strap that extends from the abdomen of the subject to a shoulder of the subject.

14. The compression device of claim 7, wherein the at least one support or the pressure applicator includes a fastener for connecting to an undergarment worn by the subject.

15. The compression device of claim 7, wherein:
the at least one support is adjustable;
the pressure applicator is connected to the at least one adjustable support;
the regulator is configured to maintain a selected position of the at least one support;
the selected position capable of being adjusted by the subject to control the amount of compressive pressure applied by the pressure pad to the treatment zone of the subject.

16. The compression device of claim 15, wherein the at least one support is a strap.

17. The compression device of claim 16, wherein the at least one strap includes calibrations or markings indicating a range of compressive pressure that may be applied.

18. The compression device of claim 16, wherein the at least one strap includes calibrations or markings for adjusting the amount of compressive pressure or adjusting the selected position.

19. The compression device of claim 1, wherein the pressure applicator and the pressure regulator comprise:
lacing connecting ends of a support; and
knobs coupled to the lacing that, when rotated, adjust and control a width or tightness of the lacing.

20. The compression device of claim 19, wherein the knobs or the lacing or both the knobs and the lacing include markings or notches indicating an amount of titrated pressure.

21. The compression device of claim 1, wherein the pressure applicator includes an inflatable bladder for applying the compressive pressure to the treatment zone of the subject.

22. The compression device of claim 21, wherein the regulator includes a pump and release valve for controlling the amount of compressive pressure.

23. The compression device of claim 22, wherein the regulator is configured to be manually adjusted by the subject.

24. The compression device of claim 21, wherein the at least one support is adjustable.

25. The compression device of claim 1, further comprising a dorsal support connected to the at least one support.

26. A compression device comprising:
at least one support;
a pressure applicator connected to the at least one support, the pressure applicator configured to apply compressive pressure to a treatment zone on an abdomen of a subject; and
means for controlling an amount of the compressive pressure applied to the subject by the pressure applicator from a minimum pressure to a maximum pressure as selected by the subject.
